(19) United States
(12) Patent Application Publication
(10) Pub. No.: US 2026/0366876 A1
(43) Pub. Date: Nov. 19, 2026

(54) COMPASS SYSTEM

(71) Applicant: SCOUT MOTORS INC., Tysons, VA (US)

(72) Inventors: David SACCHETTI, Grosse Pointe Woods, MI (US); Terry HAGGERTY, Canton, MI (US); John GORIAL, Troy, MI (US); McLane MENTING, Waterford Township, MI (US); Evan ALLEN, Hazel Park, MI (US)

(21) Appl. No.: 19/208,366

(22) Filed: May 14, 2025

(51) Int. Cl. G01C 21/26; B60K 35/21; B60K 35/28; G01C 17/24

(52) U.S. Cl. CPC G01C 21/265; B60K 35/213; B60K 35/28; G01C 17/24

(57) ABSTRACT

A compass system is provided that includes a processor configured to receive information regarding a direction of a vehicle that carries the compass system and to provide control signals based on the information. The compass system also includes a compass display configured to indicate the direction of the vehicle responsive to the control signals provided by the processor. The processor is configured to receive the information regarding the direction of the vehicle that has been captured in an environment having less electromagnetic interference than an environment in which the compass display is located.

### TECHNOLOGICAL FIELD

A compass system is provided in accordance with an example embodiment so as to provide directional information for a driver or a passenger of a vehicle.

### BACKGROUND

Drivers or passengers of a vehicle oftentimes desire to know the direction of a vehicle, such as the direction in which the vehicle is currently traveling, the orientation of the vehicle or the like. One technique for providing directional information is a compass having a compass dial with positional indicators, such as N, SE, W, etc., to designate a direction. Once the compass changes direction, the compass dial is repositioned relative to the housing of the compass to indicate the current direction, such as the current direction in which the compass is traveling.

The compass may be magnetically actuated. In this regard, the compass dial may be associated with the one or more magnets, such as by being co-located with and, in some embodiments, mechanically attached to the one or more magnets. The magnets interact with the earth's magnetic field and are repositioned as the compass changes direction such that the magnets maintain the same orientation relative to the earth's magnetic field. Thus, as the compass moves and the orientation of the compass moves relative to the magnetic field, the magnets and, in turn, the compass dial that moves in concert with the magnets are correspondingly repositioned relative to the compass to present the current orientation relative to the earth's magnetic field.

There may be drawbacks to using such a compass in a vehicle. For example, mounting the compass near the metallic frame or body of the vehicle, such as the roof, roof supports or the like of the vehicle, or electronic components of the vehicle may create electromagnetic interference for the compass and, more particularly, for the magnets that control the position of the compass dial. As such, the accuracy with which a compass indicates the current direction of the vehicle may be adversely impacted by the electromagnetic interference created by the interaction of the magnets of the compass with the metallic frame or body of the vehicle and electronic components.

### BRIEF SUMMARY

In an example embodiment, a compass system is provided that includes a processor configured to receive information regarding a direction of a vehicle and to provide control signals based thereon. The compass system also includes a motor, such as a stepper motor or a servo motor, configured to provide display positioning signals based at least in part upon the control signals provided by the processor. The compass system further includes a compass dial configured to be positioned in response to the display positioning signals provided by the motor in order to indicate the direction of the vehicle.

The compass system of an example embodiment also includes a motor driver configured to receive the control signals provided by the processor and to provide drive signals to the motor based upon the control signals. In an example embodiment, the compass system also includes an at least partially spherical housing in which the compass dial is disposed. The compass system may also include a light source configured to backlight the compass dial.

The compass system of an example embodiment may further include a directional sensor configured to provide the information regarding the direction of the vehicle. In this embodiment, the compass dial is located in an environment having greater electromagnetic interference than an environment in which the directional sensor is located. The directional sensor of one embodiment may include at least one magnetic sensor, remote from the compass dial, configured to provide information to the processor regarding the direction of the vehicle. In another embodiment, the directional sensor includes a global positioning system (GPS) receiver configured to provide information to the processor regarding the direction of the vehicle. The compass system of another example embodiment also includes a communications interface configured to communicate with a device that is carried by but is operational separate from the vehicle. In this embodiment, the communications interface is also configured to receive the information regarding the direction of the vehicle that is provided by the device.

In another embodiment, a compass system is provided that includes a processor configured to receive information regarding a direction of a vehicle that carries the compass system and to provide control signals based on the information. The compass system also includes a compass display configured to indicate the direction of the vehicle responsive to the control signals provided by the processor. The processor is configured to receive the information regarding the direction of the vehicle that has been captured in an environment having less electromagnetic interference than an environment in which the compass display is located.

The compass display of an example embodiment includes a compass dial and the compass system further includes a motor configured to provide display positioning signals to the compass dial based at least in part upon the control signals provided by the processor. The compass dial of this embodiment is configured to be positioned in response to the display positioning signals provided by the motor in order to indicate the direction of the vehicle. The compass system may also include a motor driver configured to receive the control signals provided by the processor and to provide drive signals to the motor based upon the control signals.

The compass system of an example embodiment also includes an at least partially spherical housing with the compass display being positioned within the at least partially spherical housing. The compass display may include a digital display that is responsive to the control signals to present an image of a compass dial that is oriented so as to indicate the direction of the vehicle. The digital display may be comprised of a flexible display surface upon which the image of the compass dial is presented. In one embodiment, the compass display surface includes a display surface upon which an image of a compass dial is presented and a conical reflector configured to reflect the image of the compass dial that is presented by the display surface so as to indicate the direction of the vehicle. The compass display may be positioned within an overhead console of the vehicle. In this embodiment, the compass system may also include a directional sensor, such as at least one magnetic sensor or a global positioning system (GPS) receiver, spaced apart from the overhead console and configured to provide the information regarding the direction of the vehicle, wherein the directional sensor comprises.

In a further embodiment, a compass system is provided that includes a housing, a digital display positioned within the housing and a processor configured to receive information regarding a direction of a vehicle and to provide control signals based thereon. The digital display is responsive to the control signals to present an image of a compass dial that is oriented so as to indicate the direction of the vehicle.

The digital display of an example embodiment is comprised of a flexible display surface comprising an emissive electroluminescent layer upon which the image of the compass dial is presented. The compass system may also include a directional sensor spaced apart from the housing and configured to provide the information regarding the direction of the vehicle. The directional sensor may include at least one magnetic sensor or a global positioning system (GPS) receiver.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### BRIEF DESCRIPTION OF THE DRAWINGS

A better understanding of the subject disclosure may be obtained when the following detailed description of various embodiments is considered in conjunction with the following drawings, in which:

FIG. 1 is a fragmentary side view of a vehicle including a compass mounted on an overhead console of the vehicle;

FIG. 2 is a side view of a compass including a compass display within a housing, in accordance with one or more embodiments of the present disclosure;

FIG. 3 is an exploded view of the housing and the compass display of the compass of FIG. 2, in accordance with one or more embodiments of the present disclosure;

FIG. 4 is a block diagram of a compass system, in accordance with one or more embodiments of the present disclosure;

FIG. 5 is a block diagram of another compass system, in accordance with one or more embodiments of the present disclosure;

FIGS. 6a and 6b are a side view and a top view, respectively, of a compass configured to reflect the image of a compass dial, in accordance with one or more embodiments of the present disclosure; and

FIGS. 7a and 7b are a side view and a top view, respectively, of a compass configured to reflect the image of a compass dial in a circular manner, in accordance with one or more other embodiments of the present disclosure.

### DETAILED DESCRIPTION

The examples and embodiments set forth below represent information to enable those skilled in the art to practice the subject disclosure. Upon reading the following description in light of the accompanying drawing figures, those skilled in the art will understand the concepts of the description and will recognize applications of these concepts not particularly addressed herein. It should be understood that these concepts and applications fall within the scope of the description.

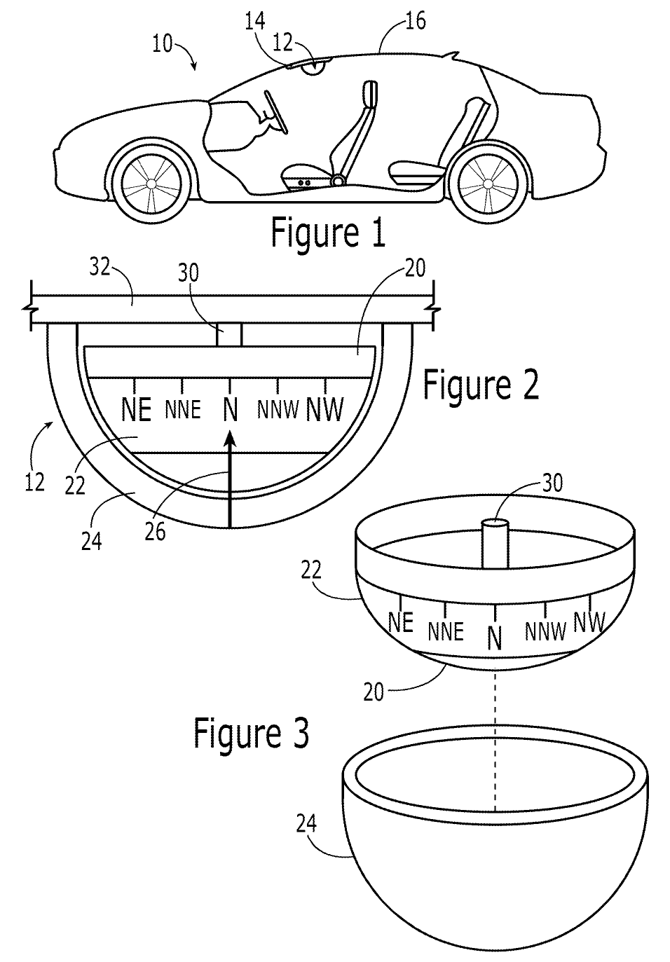

A compass is utilized to indicate the direction in which the compass is oriented relative to the earth’s magnetic field. It may be desirable to utilize a compass in a variety of applications including, for example, in vehicles to indicate the direction of the vehicle relative to the earth's magnetic field, such as the direction of travel of the vehicle, the orientation of the vehicle or the like. As shown in FIG. 1, a passenger vehicle 10, such as an automobile, a sport utility vehicle, a truck or the like, may include an embodiment of a compass 12 for providing directional information to the driver or a passenger of the vehicle. However, other types of vehicles may also include a compass, such as a boat or other type of marine vehicle.

With respect to a passenger vehicle 10 that includes a compass 12, it may be desirable to position the compass in a location in the vehicle that is subject to interference that would impact the operation of an analog, magnetic compass. However, using an electronic replacement for an analog, magnetic compass may not achieve the desired look and operation that reflects an analog, magnetic compass, as desired. For example, it may be desirable for the compass to be mounted to or otherwise included within the overhead console 14 of the vehicle as shown in FIG. 1, where there may be substantial electromagnetic interference from the metallic frame and roof of the vehicle and the other electronic components located in or proximate the overhead console. In doing so, the driver or a passenger of the vehicle would be able to determine the current direction of the vehicle, such as the direction in which the vehicle is traveling, by reference to the compass with limited disruption to watching the road. It may also be desirable to mount the compass in different locations that are similarly subject to significant electromagnetic interference, such as on the dashboard of an automobile or a boat.

With reference to FIG. 2, the compass 12 of the illustrated embodiment includes a compass display 20 and a housing 24 within which the compass display is disposed. The housing is formed of a transparent or at least partially transparent or translucent material such that the compass display within the housing can be viewed through the housing. Although the housing may be formed of various materials, the housing can be formed of a plastic material. The housing and, in turn, the compass display may have various shapes. In the illustrated embodiment, the housing has an at least partially spherical shape, such as a hemispherical shape.

The compass display 20 can also have various shapes. In the illustrated embodiment the compass display has a shape that is comparable to, such as identical to, the shape of the housing 24, such as an at least partially spherical shape, e.g., a hemispherical shape. The compass display may be formed of a metallic or plastic object meant to be identical to or similar in appearance to the compass display of an analog, magnetic compass. As shown in FIG. 2 and in more detail in the exploded view of FIG. 3, the compass display 20 includes a plurality of positional indicators, such as north (N), northwest (NW), west (W), southwest (SW), south (S), southeast (SE), east (E) and northeast (NE), positioned evenly about its surface. More granular positional indicators may also be provided by the compass display, such as south southwest or the like. The compass 12 also includes a marker 26 that designates a predefined fixed position on or relative to the housing. The marker is visible and the presentation of the positional indicators provided by the compass display is configured to change relative to the housing and the marker as the direction of the vehicle 10 changes such that the positional indicator of the compass display that is aligned with the marker indicates the current direction of the vehicle, such as the current direction in which the vehicle is traveling or is otherwise oriented. As also shown in FIGS. 2 and 3, the compass can include a shaft 30 or other connector that connects the compass display to a base member 32. The base member may be a portion of the overhead console 14 or another fixture to which the compass 12 is mounted. The shaft may connect the compass display to the base member in either a fixed relationship or in a manner that permits the compass display to rotate relative to the base member and the housing, as described below.

The compass display 20 of certain embodiments of the present disclosure is controlled based upon information regarding the direction of the vehicle 10 that is captured in an environment having less electromagnetic interference than the environment in which the compass display is located. As such, the information regarding the direction of the vehicle may be more accurate and, in turn, the indication of the direction of the vehicle provided by the compass display may be more accurate than the directional indication provided by a compass display that is positioned based upon magnets carried by the compass display that are proximate the metallic frame or body of the vehicle, or other electronic components of the vehicle that cause interference, such as in an instance in which the compass display is positioned on the overhead console of the vehicle near the metallic body 16, e.g., metallic roof, or other metallic frame or body components, or electronic components, of the vehicle. In order to reduce the deleterious effects of electromagnetic interference, the information regarding the direction of the vehicle may be captured in accordance with an example embodiment at another location further removed from the metallic frame or body, or electronic components, of the vehicle.

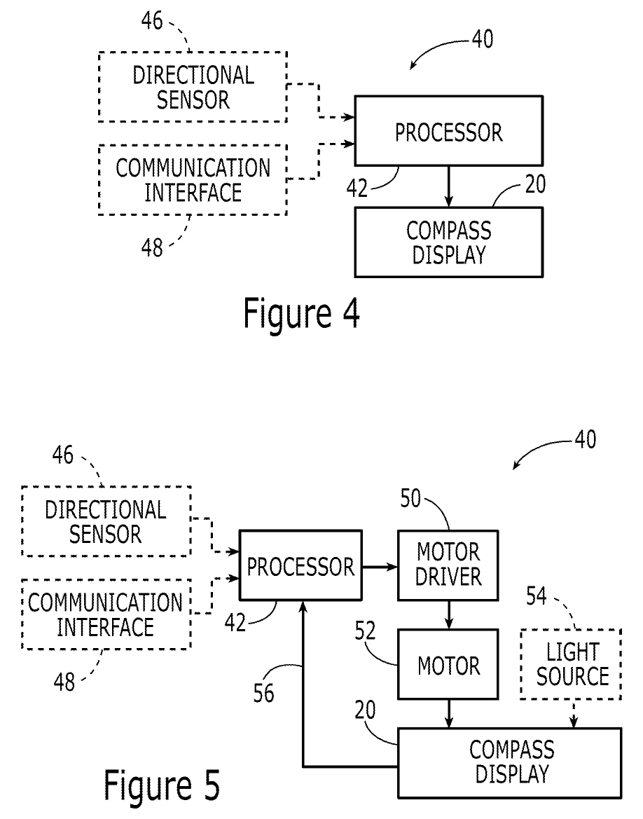

Since the compass display 20 of an example embodiment is not controlled based on the interaction of magnets carried by the compass display relative to the earth's magnetic field, the compass display must be differently controlled so as to indicate to the driver or other passenger of the vehicle 10 the current direction of the vehicle. Referring now to FIG. 4, a compass system 40 in accordance with an example embodiment is illustrated. The compass system of FIG. 4 includes a compass display having the positional indicators and a processor 42 configured to receive information regarding the direction of the vehicle that carries the compass system and to provide control signals to the compass display based on the information. The information received by the processor 42 may specify the direction of the vehicle, or in another embodiment, the processor 42 may be configured to determine the direction of the vehicle based on the information received regarding the direction of the vehicle. The processor may be embodied in a number of different ways. For example, the processor may be embodied as one or more of various hardware processing means such as a coprocessor, a microprocessor, a controller, a digital signal processor (DSP), a processing element with or without an accompanying DSP, or various other types of processing circuitry including integrated circuits such as, for example, an ASIC (application specific integrated circuit), an FPGA (field programmable gate array), a microcontroller unit (MCU), a hardware accelerator, a special-purpose computer chip, or the like.

In response to the control signals provided by the processor 42, the compass display 20 is configured to indicate the direction of the vehicle 10. In one embodiment, the information received by the processor regarding the direction of the vehicle has been captured in an environment having less electromagnetic interference than the environment in which the compass display is located.

The information regarding the direction of the vehicle 10 may be captured in various manners for subsequent provision to the processor 42. As shown in FIG. 4, the information regarding the direction of the vehicle may be captured by a directional sensor 46 that is in communication with the processor and configured to provide information regarding the direction of the vehicle that has been captured by the directional sensor to the processor. Various types of directional sensors may be utilized to capture the information regarding the direction of the vehicle. For example, the directional sensor may be a magnetic sensor. In this example embodiment, the magnetic sensor is spaced apart from the compass display 20 and is positioned within the vehicle so as to experience less electromagnetic interference than the environment in which the compass display is located. As such, the magnetic sensor may be carried by the vehicle and located in a manner that is spaced apart from the metallic frame or metallic body 16 of the vehicle. For example, the magnetic sensor may be located at least 300_millimeters from an electronic device or metallic surface likely to cause substantial interference with the magnetic sensor. By way of example, but not of limitation, the magnetic sensor may be located on the exterior of the vehicle, such as the roof, one or both side mirrors or a rear spoiler, or on the rear view mirror.

Alternatively, the directional sensor 46 may be a global positioning system (GPS) receiver carried by the vehicle 10 and configured to communicate with a GPS system in order to receive and provide information regarding the direction of the vehicle. In this embodiment, the GPS receiver and the information provided by the GPS receiver regarding the direction of the vehicle are also subject to less electromagnetic interference than is the compass display 20 itself. The information regarding the direction of the vehicle may be provided by the GPS receiver to the processor 42 in various manners. In one example embodiment, the information regarding the direction of the vehicle may be provided by the GPS receiver to an electronic control unit (ECU) onboard the vehicle. The information regarding the direction of the vehicle may specify the direction of the vehicle, the ECU may determine the direction of the vehicle based on the information regarding the direction of the vehicle, or the ECU may provide the information regarding the direction of the vehicle to the processor for the processor to determine the direction of the vehicle. The ECU transmits information regarding the direction of the vehicle via a communication bus, such as a local interconnect network (LIN) or a controller area network (CAN), for receipt by the processor. In some embodiments, a bus transceiver may be associated with the processor and configured to receive the information regarding the direction of the vehicle that is transmitted via the communication bus and to provide information regarding the direction of the vehicle to the processor.

In an alternative embodiment that is also depicted in FIG. 4, the compass system 40 may include a communication interface 48 that is carried by the vehicle 10 instead of or in addition to the directional sensor 46. The communication interface is configured to allow for a wired or wireless connection with a device that is carried by the vehicle, such as by being onboard the vehicle, but is a separate and discreet device relative to the vehicle. For example, the device may be a user device, such as a mobile telephone, a tablet computer or the like, that is configured to obtain or generate information regarding the direction of travel of the device and, as a result, information regarding the direction of travel of the vehicle since the device is onboard and traveling in the same direction as the vehicle. The device may be configured to determine the information regarding the direction of the vehicle in various manners including, for example, based upon a compass included within the device or based upon by a GPS receiver or other type of navigation system included within the device that is configured to provide information regarding the position and orientation of the device and, in turn, the vehicle. The information regarding the direction of the vehicle may specify the direction of the vehicle. Regardless of the manner in which the device determines the information regarding the direction of the vehicle, the device is configured to communicate via the communications interface with the processor 42 and to provide the information regarding the direction of the vehicle.

In any of these embodiments described above with respect to FIG. 4, the information that is provided to the processor 42 of the compass system 40 regarding the direction of the vehicle 10 has been captured in a manner that is subject to less electromagnetic interference than that experienced by the compass display 20, such as a result of the proximity of the compass display to the metallic body 16 or other metallic frame or component of the vehicle. As such, the information regarding the position and orientation of the vehicle and, in turn, the indication provided by the compass display of the current orientation of the vehicle may be more accurate.

The compass display 20 may be configured in various manners. For example, the compass display may be a compass dial 22 that is configured to mechanically rotate, such as by rotating about the shaft 30 relative to the housing 24 such that the positional indicator carried by the compass dial that is indicative of the direction of the vehicle 10 is aligned with the marker 26. The compass dial 22 may be the same as, or similar in appearance to, an analog, magnetic compass dial. One example of this embodiment is depicted in FIG. 5.

As described above, the compass system 40 of this embodiment includes the processor 42 configured to receive information regarding the direction of the vehicle 10. In the example of FIG. 5, the information regarding the direction of the vehicle may be provided by a directional sensor 46, such as a magnetic sensor, a GPS receiver or the like, or via a communication interface 48 that provides information regarding the current direction of the vehicle that is provided by a device, such as a user device, that is separate from but carried by the vehicle. Since the information regarding the direction of the vehicle is captured in an environment that is subject to less electromagnetic interference than that experienced by the compass display 20, the information that is provided regarding the direction of the vehicle may be more accurate and the compass dial 22 may be positioned, in turn, to more accurately represent the current direction of the vehicle. In the illustrated embodiment, the compass display may be configured to provide position feedback 56 to the processor that is indicative of the position of the compass dial. The position feedback enables the processor of this embodiment to be calibrated, such as upon powering up of the compass system or resetting of the compass system, such that the processor can be aware of the current position of the compass dial and properly position the compass dial during subsequent operation of the compass system.

In this embodiment depicted in FIG. 5, the compass system 40 also includes a motor driver 50 and an associated motor 52 for controllably positioning the compass dial 22 of the compass display 20 so as to accurately indicate the current direction of the vehicle 10. The processor 42 may embody or include the motor driver, or the motor driver may be a separate driver circuit that is responsive to the processor. The processor of this example embodiment is configured to provide control signals in order to direct operation of the motor in response to and based upon the information regarding the current direction of the vehicle. In an embodiment in which the information regarding the direction of the vehicle is provided in an analog form, such as by a magnetic sensor, the processor is configured to process the information and to provide digital control signals to the motor to direct operation of the motor. In this example embodiment, the motor driver receives the control signals provided by the processor and provides corresponding drive signals to the motor based thereupon. In this regard, the motor driver is configured to interpret the control signals provided by the processor and to provide corresponding drive signals to the motor so as to controllably position the compass dial as directed by the control signals. The motor driver may also be configured to condition the control signals such that the corresponding drive signals provided by the motor driver to the motor have the appropriate form so as to be properly interpreted by the motor in order to cause the intended action.

In response, the motor 52 is configured to provide display positioning signals based at least in part upon the control signals provided by the processor 42 and, more particularly, based upon the drive signals provided by the motor driver 50 which, in turn, are based upon the control signals provided by the processor. The compass system 20 may include various types of motors. For example, the compass system may include a stepper motor or a servo motor operating under control of the motor driver. The motor is also connected, such as by a mechanical connection including, for example, the shaft 30, to the compass dial 22 so as to controllably position the compass dial in response to the information regarding the direction of the vehicle 10

In an instance in which the direction of the vehicle 10 changes, such as in an instance in which a vehicle makes a turn, the information regarding the direction of the vehicle will correspondingly change and the signals provided by the motor driver 50 to the motor 52 will likewise change such that the motor will cause the compass dial 22 to be repositioned to indicate the current direction of the vehicle. In an embodiment in which the motor is a servo motor, the servo motor may be configured to smoothly move the compass dial from a first position indicating the prior direction of the vehicle to a second position indicating the current direction of the vehicle. Similarly, in an embodiment in which the motor is a stepper motor, the stepper motor may be configured to cause the compass dial to move from a first position indicating the prior direction of the vehicle to a second position indicating the current direction of the vehicle. The stepper motor of an example embodiment may be configured to cause the compass dial to move in accordance with a plurality of small steps such that the movement of the compass dial appears relatively smooth.

In response to a change in direction of the vehicle 10, the processor 42 of an example embodiment is configured to provide display positioning signals that direct the motor driver 50 to cause the motor 52 to rotate the compass dial 22 in a first rotational direction from the first position indicating the prior direction of the vehicle toward the second position indicating the current direction of the vehicle. In one embodiment, however, the display positioning signals provided by the processor may include first display positioning signals to direct the compass dial to continue in the first rotational direction beyond, such as slightly beyond, the second position indicating the current direction of the vehicle to an intermediate position. In this embodiment, the processor then provides second display positioning signals to direct the compass dial to return from the intermediate position to the second position indicative of the current direction of the vehicle. As such, the processor of this example embodiment is configured to cause the compass dial to overshoot the second position indicative of the current direction of the vehicle when moving from the first position indicating the prior direction of the vehicle toward the second position indicating the current direction of the vehicle and to then return to the second position indicative of the current direction of the vehicle, thereby mimicking the manner in which a magnetically actuated compass responds to a change in direction. Rather than providing signals to overshoot the position indicative of the current direction a single time before returning to the position indicative of the current direction, the processor may be configured to provide additional positioning intervening signals that continue to alternately overshoot and undershoot the position indicative of the current direction of the vehicle in increasingly smaller amounts to further mimic the manner in which a magnetically actuated compass responds by wobbling around, before settling on, a changed direction.

Although the compass 12 may have various form factors, the compass of an example embodiment has an at least partially spherical shape, such as a hemispherical shape. In this example embodiment, the compass may include a housing 24 formed of a transparent, a translucent or an at least partially translucent material, such as a plastic material. The compass display 20, such as the compass dial 22, is positioned within the housing and is configured for movement, such as rotational movement, relative to the housing. The housing, in turn, may be mechanically attached to the vehicle, such as to an overhead console 14 of a vehicle 10 and, in one embodiment, to a base member 32 within the overhead console. In one embodiment, the housing is attached to the vehicle, such as the overhead console, by a bezel or other attachment mechanism. In some example embodiments, the compass also includes a light source 54, such as a light emitting diode or other light, for backlighting the compass display. One or both of the compass display 20 and the compass dial 22 may be positioned such that the bottom of the compass display or compass dial is directed toward the bottom of the vehicle, or one or both of the compass display and the compass dial 22 may be positioned at an angle that is not directly toward the bottom of the vehicle to improve function or visibility of the compass display.

In another embodiment, the compass display 20 includes a digital display, such as a light emitting display and, more particularly, an organic light emitting display (OLED). The digital display of this example embodiment is responsive to control signals provided by the processor 42 as shown in FIG. 4 and is configured to provide a display of a compass dial upon the digital display with the compass dial oriented such that the positional indicator on the compass dial that is representative of the current direction of the vehicle 10 is aligned with the marker 26 of the compass 12. As the direction of the vehicle changes, the control signals provided by the processor correspondingly change to cause the presentation of the compass dial upon the digital display to be modified such that the positional indicator on the compass dial that is representative of the current direction of the vehicle is in alignment with the marker.

In an example embodiment, the digital display is a flexible display, such as a flexible organic light emitting diode display. As such, the flexible display may be formed or shaped into an at least partially spherical shape, such as a hemispherical shape, upon which the display of the compass dial is presented. The flexible display may include an emissive electroluminescent layer upon which display is presented. In an alternative embodiment, the digital display may be in a rounded, tubular, or other shape that is best suited to display the directional information in the compass display.

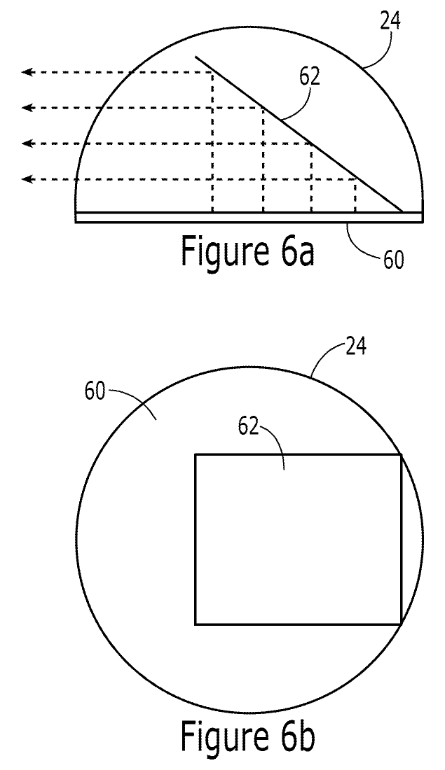

In another embodiment, the compass display 20 includes a display surface upon which an image of a compass dial is presented. The display surface may comprise a digital display, such as a light emitting display and, more particularly, an OLED. As shown in FIG. 6a, the display surface 60 may be positioned at the base of the housing 24 and may be a planar surface. The compass display of this embodiment also includes a reflector 62, such as a mirror or other reflective surface, configured to reflect the image of the compass dial that is presented upon the display surface through the housing so as to indicate the direction of the vehicle.

In operation, the processor 42 is configured to provide control signals to the display surface 60 to present an image of the compass dial. As indicated by the dashed lines of FIG. 6a, the image of the compass dial is then reflected by the reflector 62 through the housing 24 of the compass 12 for viewing by the driver or other passenger of the vehicle 10. As described above, the compass, such as the housing of the compass, may include a marker 26 and the processor may provide control signals to the display surface such that the image of the compass dial that is presented by the display surface and reflected by the reflector is oriented relative to the marker such that the reflected image of the positional indicator of the compass dial that indicates the current direction of the vehicle is aligned with the marker.

The display surface 60 and the reflector 62 of this embodiment may be configured in various manners. In one example embodiment depicted in FIGS. 6a and 6b, the display surface is planar and is positioned in the same plane as the surrounding surface of the overhead console 14. The reflector is positioned at an angle relative to the display surface, such as at an angle between 30° and 60°, such as 45° in order to reflect the image of the compass dial to the driver or other passenger of the vehicle 10. In this example embodiment, the reflector is not only positioned at an angle relative to the display surface, but extends upwardly at an angle from an edge or side portion of the display surface such that the entirety or at least the majority of the compass dial presented by the display surface is reflected by the reflector. In the example embodiment of FIGS. 6a and 6b, the compass 12 is oriented such that the portion of the housing 24 through which the compass dial is reflected faces the interior of the vehicle, such as by facing the driver of the vehicle 10 or the like. Alternatively, the compass display may include multiple reflectors, or multiple display surfaces at different angles, to project the same image, or different images, in different directions or the compass for simultaneous viewing by the driver and one or more other passengers.

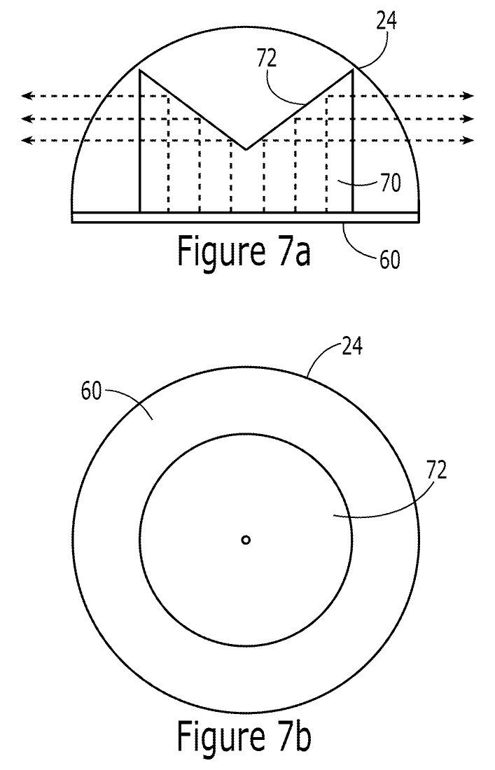

In another embodiment, the reflected image of the compass dial is provided in a circular manner as depicted in FIGS. 7a and 7b so as to provide a full 360° view. In this example embodiment, the display surface is again a planar surface and may be aligned with and coplanar with a surface of the overhead console 14 in proximity to the compass 12. The compass display 20 of this embodiment includes a conically shaped reflector 72 positioned above and spaced apart from the display surface 60 so as to reflect the compass dial that is presented upon the display surface in a circular manner. Although the conically shaped reflector may be configured in various manners, the compass display of one example embodiment includes a transparent member 70 formed of a transparent or at least translucent material, such as a thin wall, glass, or plastic, that extends outwardly from the display surface and includes an exterior surface having a conical shape that serves as the reflector. Alternatively, the inside of the conical shaped reflector may be partially mirrored to enhance the contrast of the presented image. The conically shaped exterior surface is spaced apart from the display surface by the transparent member so as to reflect the image of the compass dial in a radial direction through the housing 24 of the compass as shown by the dashed lines. By reflecting respective portions of the image of the compass dial in different directions, the compass display of this example embodiment presents an image of a portion of the compass in a circular manner, such as toward the driver, toward the passenger or the like. As described above, the compass, such as the housing of the compass, may include a marker 26 and the processor may provide control signals to the display surface such that the image of the compass dial that is presented by the display surface and reflected by the reflector, such as by the conically shaped exterior surface, is oriented relative to the marker such that the reflected image of the positional indicator of the compass dial that indicates the current direction of the vehicle is aligned with the marker.

As described above, a compass system 40 is disclosed that provides a number of advantages. For example, the compass system of an example embodiment is configured to accurately position the compass display 20, even in an instance in which the compass is mounted at a location within a vehicle 10 that is subject to electromagnetic interference. As such, the compass may be positioned as desired within a vehicle, such as in a location subject to electromagnetic interference, without sacrificing directional accuracy, as a result of being driven by control signals providing information regarding the direction of the vehicle that are provided by a directional sensor that is located so as to be subject to less electromagnetic interference than the compass. Additionally, the compass system may be configured to be visually and operationally similar to a magnetically actuated compass dial even though the compass system of an example embodiment is driven by the control signals provided by a directional sensor located remote from the compass dial.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A compass system comprising:
a processor configured to receive information regarding a direction of a vehicle and to provide control signals based thereon;
a motor configured to provide display positioning signals based at least in part upon the control signals provided by the processor; and
a compass dial configured to be positioned in response to the display positioning signals provided by the motor in order to indicate the direction of the vehicle.

2. A compass system according to claim 1, further comprising a motor driver configured to receive the control signals provided by the processor and to provide drive signals to the motor based upon the control signals.

3. A compass system according to claim 1, wherein the motor comprises a stepper motor or a servo motor.

4. A compass system according to claim 1, further comprising an at least partially spherical housing in which the compass dial is disposed.

5. A compass system according to claim 1, further comprising a directional sensor configured to provide the information regarding the direction of the vehicle, wherein the compass dial is located in an environment having greater electromagnetic interference than an environment in which the directional sensor is located.

6. A compass system according to claim 5, wherein the directional sensor comprises at least one magnetic sensor, remote from the compass dial, configured to provide information to the processor regarding the direction of the vehicle.

7. A compass system according to claim 5, wherein the directional sensor comprises a global positioning system (GPS) receiver configured to provide information to the processor regarding the direction of the vehicle.

8. A compass system according to claim 1, further comprising a communications interface configured to communicate with a device that is carried by but is operational separate from the vehicle, wherein the communications interface is also configured to receive the information regarding the direction of the vehicle that is provided by the device.

9. A compass system according to claim 1, further comprising a light source configured to backlight the compass dial.

10. A compass system comprising:
a processor configured to receive information regarding a direction of a vehicle that carries the compass system and to provide control signals based on the information; and
a compass display configured to indicate the direction of the vehicle responsive to the control signals provided by the processor,
wherein the processor is configured to receive the information regarding the direction of the vehicle that has been captured in an environment having less electromagnetic interference than an environment in which the compass display is located.

11. A compass system according to claim 10, wherein the compass display comprises a compass dial, wherein the compass system further comprises a motor configured to provide display positioning signals to the compass dial based at least in part upon the control signals provided by the processor, and wherein the compass dial is configured to be positioned in response to the display positioning signals provided by the motor in order to indicate the direction of the vehicle.

12. A compass system according to claim 11, further comprising a motor driver configured to receive the control signals provided by the processor and to provide drive signals to the motor based upon the control signals.

13. A compass system according to claim 10, further comprising an at least partially spherical housing, wherein the compass display is positioned within the at least partially spherical housing.

14. A compass system according to claim 10, wherein the compass display comprises a digital display that is responsive to the control signals to present an image of a compass dial that is oriented so as to indicate the direction of the vehicle.

15. A compass system according to claim 14, wherein the digital display is comprised of a flexible display surface upon which the image of the compass dial is presented.

16. A compass system according to claim 10, wherein the compass display comprises a display surface upon which an image of a compass dial is presented and a conical reflector configured to reflect the image of the compass dial that is presented by the display surface so as to indicate the direction of the vehicle.

17. A compass system according to claim 10, wherein the compass display is positioned within an overhead console of the vehicle, and wherein the compass system further comprises a directional sensor spaced apart from the overhead console and configured to provide the information regarding the direction of the vehicle, wherein the directional sensor comprises at least one magnetic sensor or a global positioning system (GPS) receiver.

18. A compass system comprising:
a housing;
a digital display positioned within the housing; and
a processor configured to receive information regarding a direction of a vehicle and to provide control signals based thereon,
wherein the digital display is responsive to the control signals to present an image of a compass dial that is oriented so as to indicate the direction of the vehicle.

19. A compass system according to claim 18, wherein the digital display is comprised of a flexible display surface comprising an emissive electroluminescent layer upon which the image of the compass dial is presented.

20. A compass system according to claim 18, further comprising a directional sensor spaced apart from the housing and configured to provide the information regarding the direction of the vehicle, wherein the directional sensor comprises at least one magnetic sensor or a global positioning system (GPS) receiver.
